(19) United States
(12) Patent Application Publication
(10) Pub. No.: US 2014/0028780 A1
(43) Pub. Date: Jan. 30, 2014

(54) PRODUCING CONTENT TO PROVIDE A CONVERSATIONAL VIDEO EXPERIENCE

(71) Applicant: Volio, Inc., San Francisco, CA (US)

(72) Inventors: Ronald A. Croen, San Francisco, CA (US); Mark T. Anikst, Santa Monica, CA (US); Vidur Apparao, San Mateo, CA (US); Bernt Habermeier, San Francisco, CA (US); Todd A. Mendeloff, Los Angeles, CA (US)

(21) Appl. No.: 13/907,513

(22) Filed: May 31, 2013

Related U.S. Application Data
(60) Provisional application No. 61/653,921, filed on May 31, 2012.

(51) Int. Cl. H04N 7/14

(52) U.S. Cl. CPC H04N 7/141
USPC 348/14.03

(57) ABSTRACT

Producing a conversational video experience is disclosed. In various embodiments, a definition data associated with a first conversation node associated with the conversational video experience is received via a user interface. A response concept associated with the first conversation node is determined based at least in part on the received definition data. A relationship between the first conversation node and a second conversation node associated with the conversational video experience is determined based at least in part on the determined response concept. An association data that represents the relationship is generated and stored.

### CROSS REFERENCE TO OTHER APPLICATIONS

This application claims priority to U.S. Provisional Patent Application No. 61/653,921 (Attorney Docket No. NUMEP001+) entitled PRODUCING DIALOGS TO PROVIDE A CONVERSATIONAL VIDEO EXPERIENCE, filed May 31, 2012, which is incorporated herein by reference for all purposes.

### BACKGROUND OF THE INVENTION

Speech recognition technology is used to convert human speech (audio input) to text or data representing text (text-based output). Applications of speech recognition technology to date have included voice-operated user interfaces, such as voice dialing of mobile or other phones, voice-based search, interactive voice response (IVR) interfaces, and other interfaces. Typically, a user must select from a constrained menu of valid responses, e.g., to navigate a hierarchical sets of menu options.

Attempts have been made to provide interactive video experiences, but typically such attempts have lacked key elements of the experience human users expect when they participate in a conversation.

### BRIEF DESCRIPTION OF THE DRAWINGS

Various embodiments of the invention are disclosed in the following detailed description and the accompanying drawings.

FIG. 1 is a block diagram illustrating an embodiment of a system to provide a conversational video experience.

FIG. 2 is a block diagram illustrating an embodiment of a system to provide a conversational video experience.

FIG. 3 is a block diagram illustrating an embodiment of a conversational video runtime engine.

FIG. 4A is a block diagram illustrating an embodiment of a conversational video experience display and interface.

FIG. 4B is a block diagram illustrating an embodiment of a conversational video experience display and interface.

FIG. 4C is a block diagram illustrating an embodiment of a conversational video experience display and interface.

FIG. 5 is a block diagram illustrating an embodiment of a conversational video experience.

FIG. 6 is a block diagram illustrating an embodiment of a conversational video experience.

FIG. 7 is a block diagram illustrating an embodiment of a conversational video experience segment.

FIG. 8 is a flow chart illustrating an embodiment of a process to create content to provide a conversational video experience.

FIG. 9 is a flow chart illustrating an embodiment of a process to create content to provide a conversational video experience.

FIG. 10 is a block diagram illustrating an embodiment of a user interface of a tool to create content for a conversational video experience.

FIG. 11 is a flow chart illustrating an embodiment of a process to create content for a conversational video experience.

FIG. 12 is a block diagram illustrating an embodiment of a user interface of a tool to create content for a conversational video experience system.

FIG. 13 is a flow chart illustrating an embodiment of a process to create content for a conversational video experience.

FIG. 14 is a block diagram illustrating an embodiment of related sets of content for a conversational video experience.

FIG. 15 is a flow chart illustrating an embodiment of a process to facilitate creation of content for a conversational video experience.

FIG. 16 is a block diagram illustrating an embodiment of a set of content for a conversational video experience.

FIG. 17 is a flow chart illustrating an embodiment of a process to facilitate creation of content for a conversational video experience.

FIG. 18 is a flow chart illustrating an embodiment of a process to facilitate creation of content for a conversational video experience.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Producing content to provide a conversational video experience is disclosed. In various embodiments, one or more tools facilitate creation, in at least partly automated way, of content to provide a conversational video experience. In various embodiments, the content produced is used in connection with a conversational video runtime system to provide to an end user a conversational video experience. In various embodiments, the system uses the content to emulate a virtual participant in a conversation with a real participant (a user). It presents the virtual participant as a video persona, created in various embodiments based on recording or capturing aspects of a real person or other persona participating in the persona's end of the conversation. The video persona in various embodiments may be one or more of an actor or other human subject; a puppet, animal, or other animate or inanimate object; and/or pre-rendered video, for example of a computer generated and/or other participant. In various embodiments, the “conversation” may comprise one or more of spoken words, non-verbal gestures, and/or other verbal and/or non-verbal modes of communication capable of being recorded and/or otherwise captured via pre-rendered video and/or video recording. A script or set of scripts may be used to record discrete segments in which the subject affirms a user response to a previously-played segment, imparts information, prompts the user to provide input, and/or actively listens as one might do while listening live to another participant in the conversation. The system provides the video persona's side of the conversation by playing video segments on its own initiative and in response to what it heard and understood from the user side. It listens, recognizes and understands/interprets user responses, selects an appropriate response as a video segment, and delivers it in turn by playing the selected video segment. The goal of the system in various embodiments is to make the virtual participant in the form of a video persona as indistinguishable as possible from a real person participating in a conversation across a video channel. In various embodiments, the video “persona” may include one or more participants, e.g., a conversation with members of a rock band, and/or more than one real world user may interact with the conversational experience at the same time.

In a natural human conversation, both participants acknowledge their understanding of the meaning or idea being conveyed by another side and express their attitude to the understood content, with verbal and facial expressions or other cues. In general, the participants are allowed to interrupt each other and start responding to the other side if they choose to do so. These traits of a natural conversation are emulated in various embodiments by a conversing virtual participant to maintain a suspension of disbelief on the part of the user.

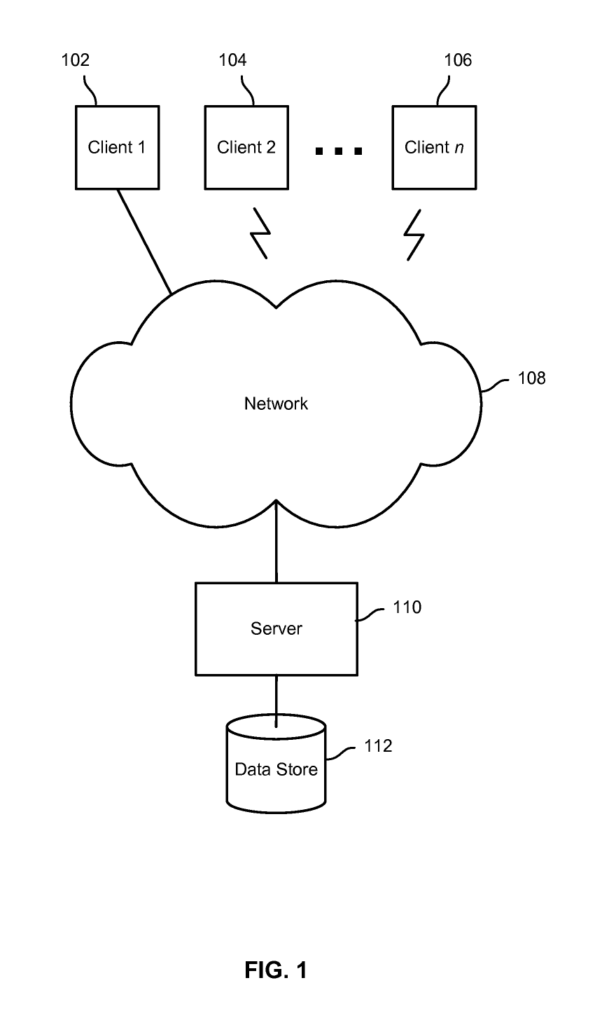

FIG. 1 is a block diagram illustrating an embodiment of a system to provide a conversational video experience. In the example shown, each of a plurality of clients, represented in FIG. 1 by clients 102, 104, 106, has access, e.g., via a wireless or wired connection to a network 108, to one or more conversational video experience servers, represented in FIG. 1 by server 110. Servers such as server 110 use conversational video experience assets stored in an associated data store, such as data store 112, to provide assets to respective ones of the clients, e.g., on request by a client side application or other code running on the respective clients, to enable a conversational video experience to be provided. Examples of client devices, such as clients 102, 104, and 106, included without limitation desktop, laptop, and/or other portable computers; iPad® and/or other tablet computers or devices; mobile phones and/or other mobile computing devices; and any other device capable of providing a video display and capturing user input provided by a user, e.g., a response spoken by the user. While a single server 110 is shown in FIG. 1, in various embodiments a plurality of servers may be used, e.g., to make the same conversational video experience available from a plurality of source, and/or to deploy different conversation video experiences from different servers. Examples of conversational video experience assets that may be stored in data stores such as data store 112 include, without limitation, video segments to be played in a prescribed order and/or manner to provide the video persona's side of a conversation and meta-information to be used to determine an order and/or timing in which such segments should be played.

A conversational video runtime system or runtime engine may be used in various embodiments to provide a conversational experience to a user in multiple different scenarios. For example:
Standalone application—A conversation with a single virtual persona or multiple conversations with different virtual personae could be packaged as a standalone application (delivered, for example, on a mobile device or through a desktop browser). In such a scenario, the user may have obtained the application primarily for the purpose of conducting conversations with virtual personae.
Embedded—One or more conversations with one or more virtual personae may be embedded within a separate application or web site with a broader purview. For example, an application or web site representing a clothing store could embed a conversational video with a spokesperson with the goal of helping a user make clothing selections.
Production tool—The runtime engine may be contained within a tool used for production of conversational videos. The runtime engine could be used for testing the current state of the conversational video in production.

In various implementations of the above, the runtime engine is incorporated and used by a container application. The container application may provide services and experiences to the user that complement or supplement those provided by the conversational video runtime engine, including discovery of new conversations; presentation of the conversation at the appropriate time in a broader user experience; presentation of related material alongside or in addition to the conversation; etc.

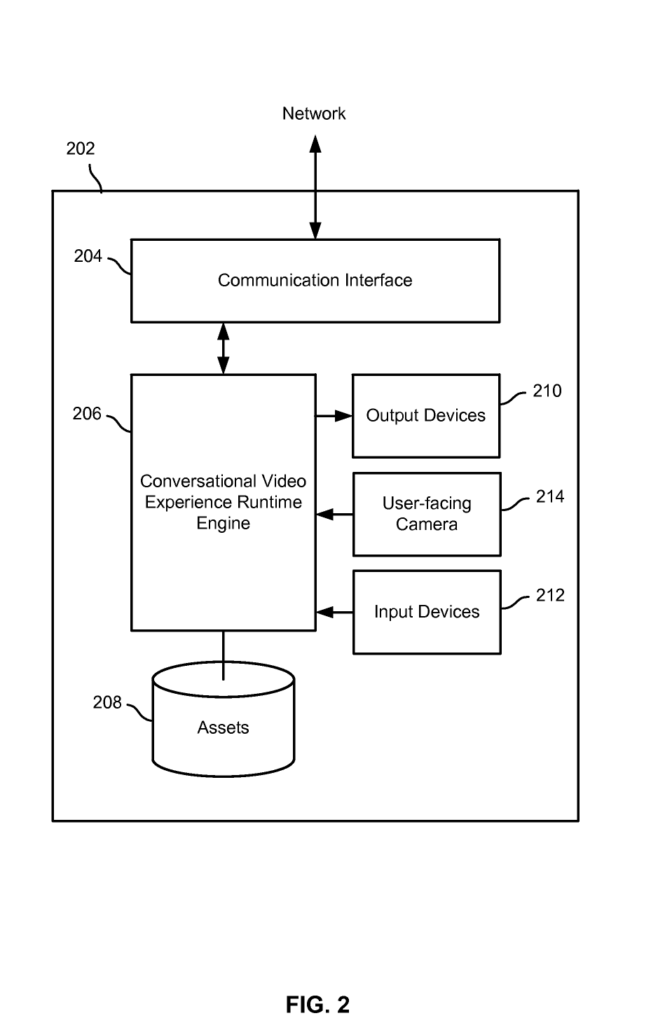

FIG. 2 is a block diagram illustrating an embodiment of a system to provide a conversational video experience. In the example shown, a device 202, such as tablet or other client device, includes a communication interface 204, which provides network connectivity. A conversational video experience runtime engine 206 communicates to the network via communication interface 204, for example to download video, meta-information, and/or other assets to be used to provide a conversational video experience. Downloaded assets (e.g., meta-information, video segments of video persona) and/or locally-generated assets (e.g., audio comprising responses spoken by the user, video of the user interacting with the experience) are stored locally in a local asset store 208. Video segments and/or other content are displayed to the user via output devices 210, such as a video display device and/or speakers. Input devices 212 are used by the user to provide input to the runtime engine 206. Examples of input devices 212 include without limitation a microphone, which may be used, for example, to capture a response spoken by the user in response to a question or other prompt by the video persona, and a touch screen or other haptic device, which may be used to receive as input user selection from among a displayed set of responses, as described more fully below. A user-facing camera 214 in various embodiments provides (or optionally provides) video of the user interacting with the conversational video experience, for example to be used to evaluate and fine-tune the experience for the benefit of future users, to provide picture-in-picture (PIP) capability, and/or to capture the user's side of the conversation, e.g., to enable the user to save and/or share video representing both sides of the conversation.

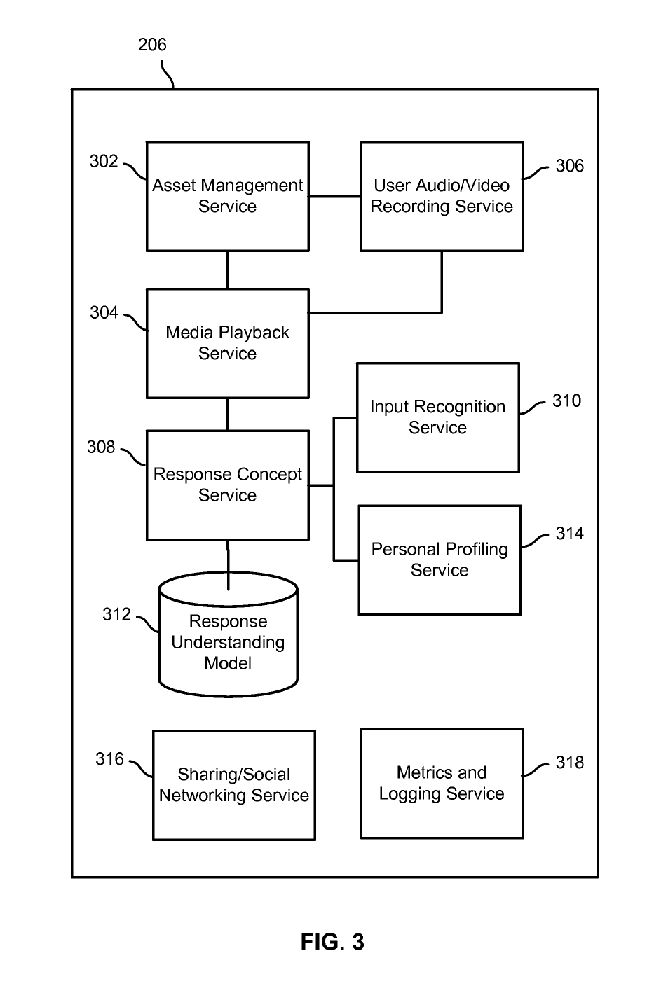

FIG. 3 is a block diagram illustrating an embodiment of a conversational video runtime engine. In various embodiments, a conversational video runtime engine may contain some or all of the components shown in FIG. 3. In the example shown, the conversational video runtime engine 206 includes an asset management service 302. In various embodiments, asset management service 302 manages the retrieval and caching of all required assets (e.g. video segments, language models, etc.) and makes them available to other system components, such as and without limitation media playback service 304. Media playback service 304 in various embodiments plays video segments representing the persona's verbal and physical activity. The video segments in various embodiments are primarily pre-recorded, but in other embodiments may be synthesized on-the-fly. A user audio/video recording service 306 captures and records audio and video of the user during a conversational video experience, e.g., for later sharing and analysis.

In the example shown in FIG. 3, a response concept service 308 determines which video segments to play at which time and in which order, based for example on one or more of user input (e.g., spoken and/or other response); user profile and/or other information; and/or meta-information associated with the conversational video experience.

A input recognition service 310 includes in various embodiments a speech recognition system (SR) and other input recognition such as speech prosody recognition, recognition of user's facial expressions, recognition/extraction of location, time of day, and other environmental factors/features, as well as user's touch gestures (utilizing the provided graphical user interface). The input recognition service 310 in various embodiments accesses user profile information retrieved, captured, and/or generated by the personal profiling service 314, e.g., to utilize personal characteristics of the user in order to adapt the results to the user. For example, if it's understood that the user is male, from their personal profiling data, in some embodiments video segments including any questions regarding the gender of the individual may be skipped, because the user's gender is known from their profile information. Another example is modulating foul language based on user preference: Assuming you have two versions of the conversation, where one version makes use of swear words, and another version that does not, in some embodiments user profile data may be used to choose which version of the conversation is used based on the user's history of swearing (or not) during the course of the user's own statements during the user's participation in the same or previous conversations, making the conversation more enjoyable, or at least more suited to the user's comfort with such language, overall. As a third example, the speech recognizer as well as natural language processor can be made more effective by tuning based on end-user behavior. The current state-of-the-art speech recognizers do allow a user based profile to be built to improve overall speech recognition accuracy on a per-user basis. The output of the input recognition service 310 in various embodiments may include a collection of one or more feature values, including without limitation speech recognition values (hypotheses, such a ranked and/or scored set of “n-best” hypotheses as to which words were spoken), speech prosody values, facial feature values, etc.

Personal profiling service 314 in various embodiments maintains personalized information about a user and retrieves and/or provides that information on demand by other components, such as the response concept service 308 and the input recognition service 310. In various embodiments, user profile information is retrieved, provided, and/or updated at the start of the conversation, as well as prior to each turn of the conversation. In various embodiments, the personal profiling service 314 updates the user's profile information at the end of each turn of the conversation using new information extracted from the user response and interpreted by the response concept service 308. For example, if a response is mapped to a concept that indicates the marital status of user, a profile data may be updated to reflect what the system has understood the user's marital status to be. In some embodiments, a confirmation or other prompt may be provided to the user, to confirm information prior to updating their profile. In some embodiments, a user may clear from their profile information that has been added to their profile based on their responses in the course of a conversational video experience, e.g., due to privacy concerns and/or to avoid incorrect assumptions in situations in which multiple different users use a shared device.

In various embodiments, response concept service 308 interprets output of the input recognition service 310 augmented with the information retrieved by the personal profiling service 314. Response concept service 308 performs interpretation in the domain of natural language (NL), speech prosody and stress, environmental data, etc. Response concept service 308 utilizes one or more response understanding models 312 to map the input feature values into a “response concept” determined to be the concept the user intended to communicate via the words they uttered and other input (facial expression, etc.) they provided in response to a question or other prompt (e.g. “Yup”, “Yeah”, “Sure” or nodding may all map to an “Affirmative” response concept). The response concept service 308 uses the response concept to determine the next video segment to play. For example, the determined response concept in some embodiments may map deterministically or stochastically to a next video segment to play. The output of the response concept service 308 in various embodiments includes an identifier indicating which video segment to play next and when to switch to the next segment.

Sharing/social networking service 316 enables a user to posts aspects of conversations, for example video recordings or unique responses, to sharing services such as social networking applications.

Metrics and logging service 318 records and maintains detailed and summarized data about conversations, including specific responses, conversation paths taken, errors, etc. for reporting and analysis.

The services shown in FIG. 3 and described above may in various embodiments reside in part or in their entirety either on the client device of the human participant (e.g. a mobile device, a personal computer) or on a cloud-based server. In addition, any service or asset required for a conversation may be implemented as a split resource, where the decision about how much of the service or asset resides on the client and how much on the server is made dynamically based on resource availability on the client (e.g. processing power, memory, storage, etc.) and across the network (e.g. bandwidth, latency, etc.). This decision may be based on factors such as conversational-speed response and cost. In some embodiments, for example, input recognition service 310 may invoke a cloud-based speech recognition service, such as those provided by Google® and others, to obtain a set of hypotheses of which word(s) the user has spoken in response to a question or other prompt by a video persona.

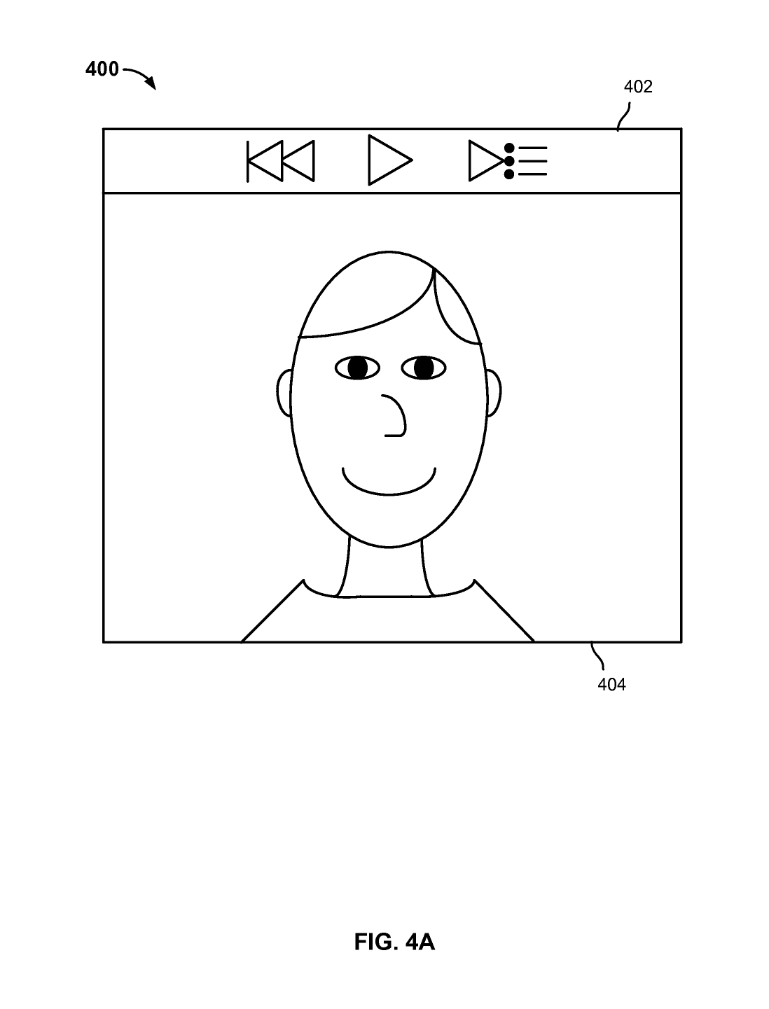

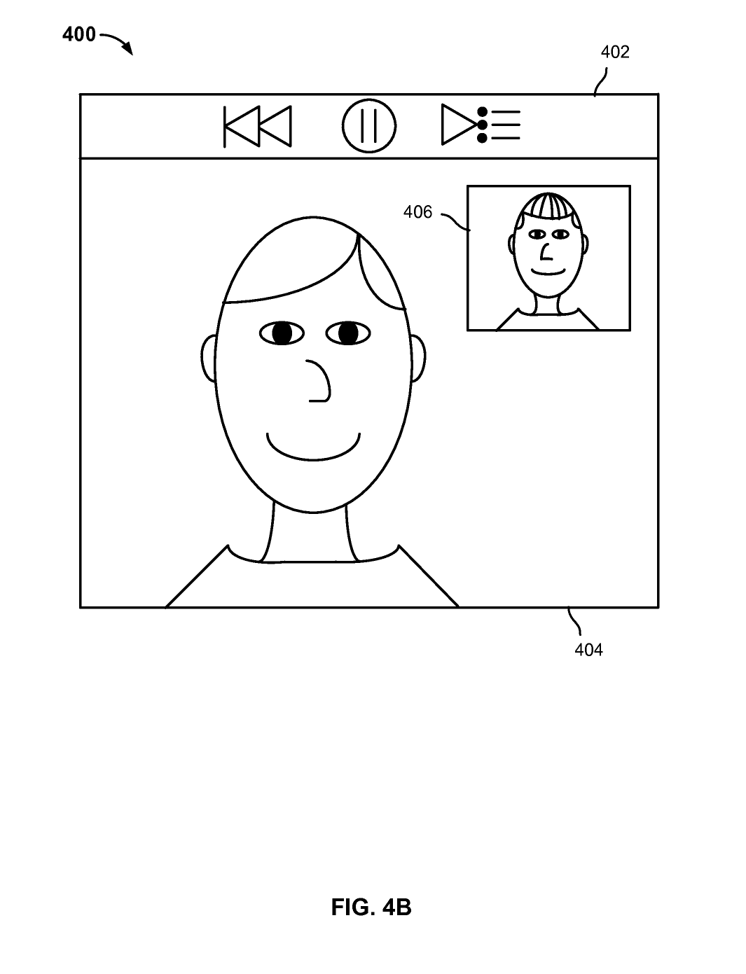

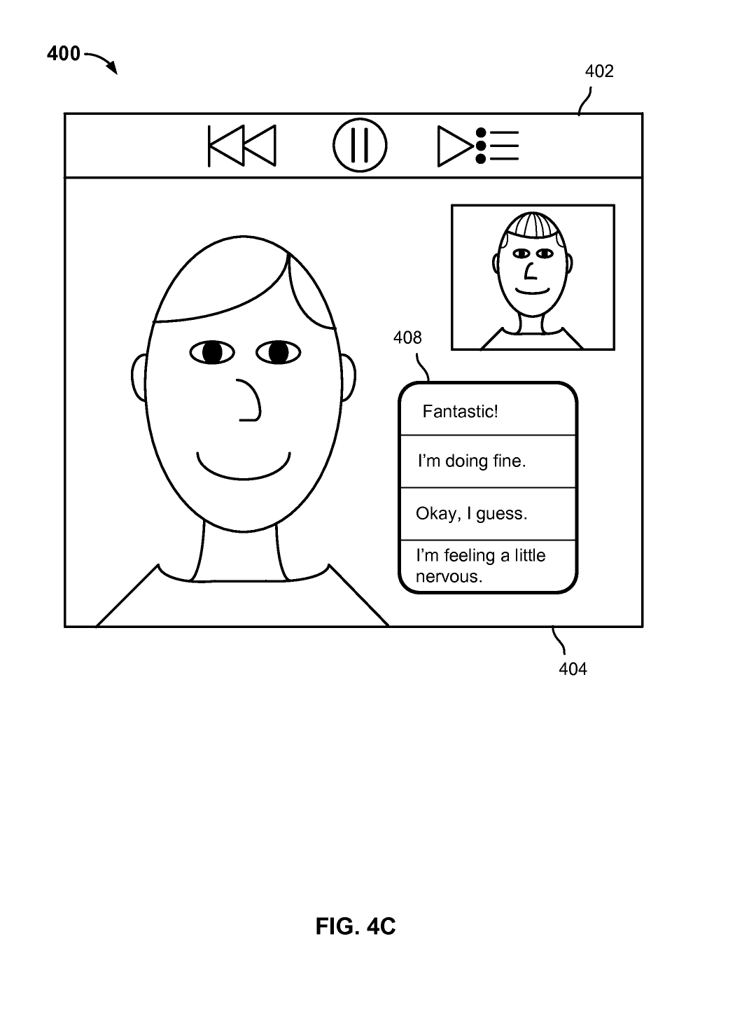

FIG. 4A is a block diagram illustrating an embodiment of a conversational video experience display and interface. In the example shown, a display 400 includes a control panel region 402 and a conversational video experience display region 404. In some embodiments, control panel region 402 is displayed and/or active only at certain times and/or conditions, e.g., once a video segment has finished playing, upon mouse-over or other pre-selection, etc. In the example shown, control panel region 402 includes three user selectable controls: at left a “rewind” control to iterate back through previously-played segments and/or responses; in the center a “play” control to indicate a readiness and desire to have a current/immediately next segment played; and at right a “forward” control, e.g., to cause a list of user-selectable responses or other user-selectable options available to advance the conversational video experience to be displayed. In the video experience display region 404, a video segment of a video persona engaged in her current “turn” of the conversation is displayed. In the example shown, a title/representative frame, or a current/next frame, of the current/next video segment is displayed, and selection of the “play” control would cause the video segment to begin (and/or resume) to play.

FIG. 4B is a block diagram illustrating an embodiment of a conversational video experience display and interface. In the example shown in FIG. 4B, the “play” control in the center of control panel region 402 has been replaced by a “pause” control, indicating in some embodiments that the current video segment of the video persona is currently playing. In addition, a picture-in-picture (PIP) frame 406 has been added to conversational video experience display region 404. In this example, video of the user of a client device comprising display 400 is displayed in PIP frame 406. A front-facing camera of the client device may be used in various embodiments to capture and display in PIP frame 406 video of a user of the client device while he/she engages with the conversational video experience. Display of user video may enable the user to ensure that the lighting and other conditions are suitable to capture user video of desired quality, for example to be saved and/or shared with others. In some embodiments, upon expiration of a prescribed time after the video persona finishes expressing a question or other prompt, a speech balloon or bubble may be displayed adjacent to the PIP frame 406, e.g., with a partially greyed out text prompt informing the user that it is the user's turn to speak.

The system in various embodiments provides dynamic hints to a user of which input modalities are made available to them at the start of a conversation, as well as in the course of it. The input modalities can include speech, touch or click gestures, or even facial gestures/head movements. The system decides in various embodiments which one should be hinted to the user, and how strong a hint should be. The selection of the hints may be based on environmental factors (e.g. ambient noise), quality of the user experience (e.g. recognition failure/retry rate), resource availability (e.g., network connectivity) and user preference. The user may disregard the hints and continue using a preferred modality. The system keeps track of user preferences for the input modalities and adapts hinting strategy accordingly.

The system can use VUI, touch-/click-based GUI and camera-based face image tracking to capture user input. The GUI is also used to display hints of what modality is preferred by the system. For speech input, the system displays a “listening for speech” indicator every time the speech input modality becomes available. If speech input becomes degraded (e.g. due to a low signal to noise ratio, loss of an access to a remote SR engine) or the user experiences a high recognition failure rate, the user will be hinted at/reminded of the touch based input modality as an alternative to speech.

The system hints (indicates) to the user that the touch based input is preferred at this point in the interactions by showing an appropriate touch-enabled on-screen indicator. The strength of a hint is expressed as the brightness and/or the frequency of pulsation of the indicator image. The user may ignore the hint and continue using the speech input modality. Once the user touches that indicator, or if the speech input failure persists, the GUI touch interface becomes enabled and visible to the user. The speech input modality remains enabled concurrently with the touch input modality. The user can dismiss the touch interface if they prefer. Conversely, the user can bring up the touch interface at any point in the conversation (by tapping an image or clicking a button). The user input preferences are updated as part of the user profile by the PP system.

For touch input, the system maintains a list of pre-defined responses the user can select from. The list items are response concepts, e.g., “YES”, “NO”, “MAYBE” (in a text or graphical form). These response concepts are linked one-to-one with the subsequent prompts for the next turn of the conversation. (The response concepts match the prompt affirmations of the linked prompts.) In addition, each response concept is expanded into a (limited) list of written natural responses matching that response concept. As an example, for a prompt “Do you have a girlfriend?” a response concept “NO GIRLFRIEND” may be expanded into a list of natural responses “I don't have a girlfriend”, “I don't need a girlfriend in my life”, “I am not dating anyone”, etc. A response concept “MARRIED” may be expended into a list of natural responses “I'm married”, “I am a married man”, “Yes, and I am married to her”, etc.

FIG. 4C is a block diagram illustrating an embodiment of a conversational video experience display and interface. In the example shown, a list of response concepts is presented via a touch-enabled GUI popup window 408. The user can apply a touch gesture (e.g., tap) to a response concept item on the list, and in response the system will start playing a corresponding video segment of the video persona. In some embodiments, the user can apply another touch gesture (e.g., double-tap) to the response concept item to make the item expand into a list of natural responses (in text format). In some embodiments, this new list will replace the response concept list in the popup window. In another implementation, the list of natural responses is shown in another popup window. The user can use touch gestures (e.g., slide, pinch) to change the position and/or the size of the popup window(s). The user can apply a touch gesture (e.g., tap) to a natural response item to start playing the corresponding video prompt. To go back to the list of response concepts or dismiss a popup window, the user can use other touch gestures (or click on a GUI button).

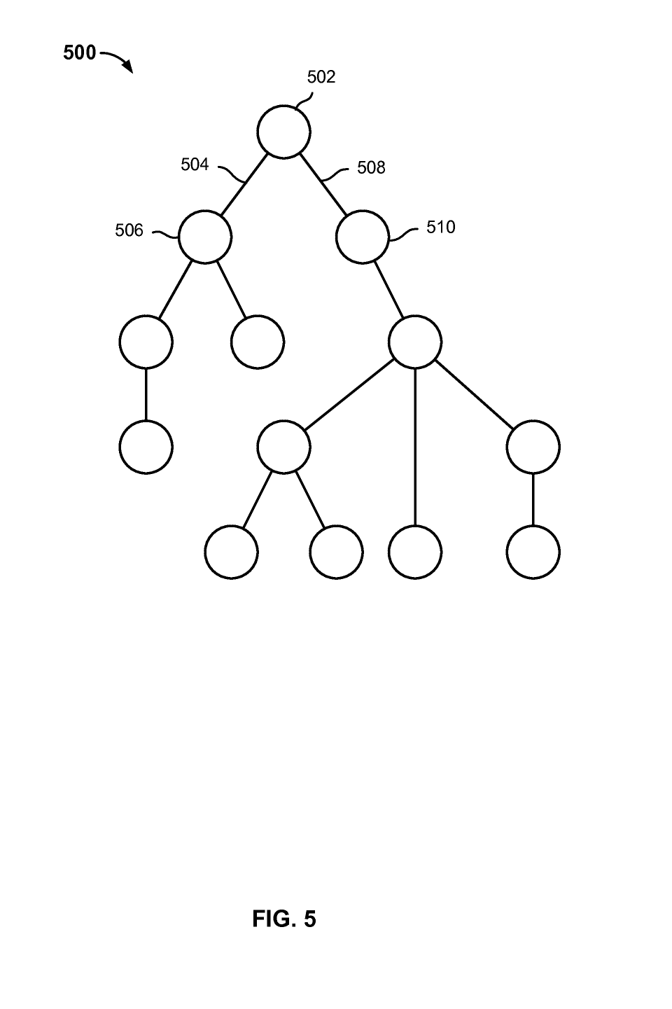

FIG. 5 is a block diagram illustrating an embodiment of a conversational video experience. In the example shown, a conversational video experience is represented as a tree 500. An initial node 502 represents an opening video segment, such as a welcoming statement and initial prompt by a video persona. In the example shown, the conversation may after the initial segment 502 follow one or two next paths. The system listens to the human user's spoken (or other) response and maps the response to either a first response concept 504 associated with a next segment 506 or to a second response concept 508 associated with a next segment 510. Depending on which response concept the user's input is mapped to, in this example either response concept 504 or response concept 508, a different next video segment (i.e., segment 506 or segment 510) will be played next. In various embodiments, a conversational experience may be represented as a directed graph, and one or more possible paths through the graph may converge at some node in the graph, for example, if respective response concepts from each of two different nodes map/link to a common next segment/node in the graph.

In various embodiments, a primary function within the runtime engine is a decision-making process to drive conversation. This process is based on recognizing and interpreting signals from the user and selecting an appropriate video segment to play in response. The challenge faced by the system is guiding the user through a conversation while keeping within the domain of the response understanding model(s) and video segments available.

For example, in some embodiments, the system may play an initial video segment representing a question posed by the virtual persona. The system may then record the user listening/responding to the question. A user response is captured, for example by an input response service, which produces recognition results and passes them to a response concept service. The response concept service uses one or more response understanding models to interpret the recognition results, augmented in various embodiments with user profile information. The result of this process is a “response concept.” For example, recognized spoken responses like “Sure”, “Yes” or “Yup” may all result in a response concept of “AFFIRMATIVE”.

The response concept is used to select the next video segment to play. In the example shown in FIG. 5, each response concept is deterministically associated with a single video segment. In some embodiments, each node in the tree, such as tree 500 of FIG. 5, has associated therewith a node-specific response understanding model that may be used to map words determined to have been uttered and/or other input provided in response to that segment to one or more response concepts, which in turn may be used to select a next video segment to be presented to the user.

The video segment and the timing of the start of a response are passed in various embodiments to a media playback service, which initiates video playback of the response by the virtual persona at an indicated and/or otherwise determined time.

In various embodiments, the video conversational experience includes a sequence of conversation turns such as those described above in connection with FIG. 5. In one embodiment of this type of conversation, all possible conversation turns are represented in the form of a pre-defined decision tree/graph, as in the example shown in FIG. 5, where each node in the tree/graph represents a video segment to play, a response understanding model to map recognized and interpreted user responses to a set of response concepts, and the next node for each response concept.

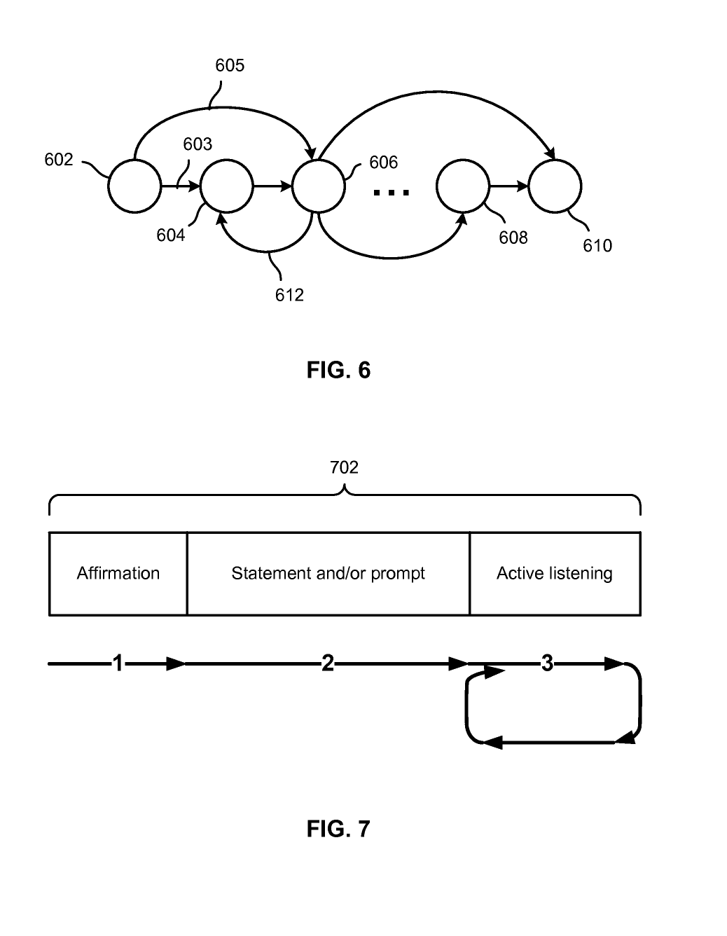

FIG. 6 is a block diagram illustrating an embodiment of a conversational video experience. In FIG. 6, a less hierarchical representation of a conversation is shown. In the example shown, from an initial node/segment 602, a user response that is mapped to a first response concept 603 results in a transition to node/segment 604, whereas a second response concept 605 would cause the conversation to leap ahead to node/segment 606, bypassing node 604. Likewise, from node 606 the conversation may transition via one response concept to node 608, but via a different response concept directly to node 610. In the example shown, a transition “back” from node 606 to node 604 is possible, e.g., in the case of a user response that is mapped to response concept 612.

In some embodiments, to enable a more natural and dynamic conversation, each conversational turn does not have to be pre-defined. To make this possible, the system in various embodiments has access to one or more of:
A corpus of video segments representing a large set of possible prompts and responses by the virtual persona in the subject domain of the conversation.
A domain-wide response understanding model in the subject domain of the conversation.

In various embodiments, the domain-wise response understanding model is conditioned at each conversational turn based on prompts and responses adjacent to that point in the conversation. The response understanding model is used, as described above, to interpret user responses (deriving one or more response concepts based on user input). It is also used to select the best video segment for the next dialog turn, based on highest probability interpreted meaning.

An example process flow in such a scenario includes the following steps:
At the start of the conversation, a pre-selected opening prompt is played.
After playing the selected prompt, the user response is captured, speech recognition is performed, and the result is used to determine a response concept. The response understanding model may be updated (conditioned) based on the user response.
The conditioned response understanding model is used to select the best possible available video segment as the prompt to play next, representing the virtual persona's response to the user response described in immediately above. To make that selection, each available prompt is passed to the conditioned response understanding model, which generates a list of possible interpretations of that prompt, each with a probability of expressing the meaning of the prompt. The highest-probability interpretation defines the best meaning for the underlying prompt and serves as its best-meaning score In principle, an attempt may be made to interpret every prompt recorded for a given video persona in the domain of the conversation, and select the prompt yielding the highest best-meaning score. This selection of the next prompt represents the start of the next conversational turn. It starts by playing a video segment representing the selected prompt.
For each conversational turn, the response understanding model can be reset to the domain-wide response understanding model and the steps described above are repeated. This process continues until the user ends the conversation, the system selects a video segment that is tagged as a conversation termination point, or the currently conditioned response understanding model determines that the conversation has ended.

The above embodiments exemplify different methods through which the runtime system can guide the conversation within the constraints of a finite and limited set of available understanding models and video segments.

A further embodiment of the runtime system utilizes speech and video synthesis techniques to remove the constraint of responding using a limited set of pre-recorded video segments. In this embodiment, a response understanding model can generate the best possible next prompt by the virtual persona within the entire conversation domain. The next step of the conversation will be rendered or presented to the user by the runtime system based on dynamic speech and video synthesis of the virtual persona delivering the prompt.

### Active Listening

To maintain a user experience of a natural conversation, in various embodiments the video persona maintains its virtual presence and responsiveness, and provides feedback to the user, through the course of a conversation, including when the user is speaking. To accomplish that, in various embodiments appropriate video segments are played when the user is speaking and responding, giving the illusion that the persona is listening to the user's utterance.

FIG. 7 is a block diagram illustrating an embodiment of a conversational video experience segment. In the example shown, a video segment 702 includes three distinct portions. In a first portion, labeled “affirmation” in FIG. 7, the video persona provides feedback to indicate that the user's previous response has been heard and understood. For example, if the user has uttered a response that has been mapped to the response concept “feeling good”, the video persona might during the affirmation portion of the segment that is selected to play next say something like, “That's great, I'm feeling pretty good today too.” In the next portion, labeled “statement and/or prompt” in FIG. 7, the video persona may communicate information, such as to inform the user, provide information the user may be understood to have expressed interest in, etc., and either explicitly (e.g., by asking a question) or implicitly or otherwise prompt the user to provide a response. While the video persona waits for the user to respond, an “active listening” portion of the video segment 702 is played. In the example shown, if an end of the active listening portion is reached before the user has completed providing a response, the system loops through the active listening portion again, and if necessary through successive iterations, until the user has completed providing a response.

In one embodiment, active listening is simulated by playing a video segment (or portion thereof) that is non-specific. For example, the video segment could depict the virtual persona leaning towards the user, nodding, smiling or making a verbal acknowledgement (“OK”), irrespective of the user response. Of course, this approach risks the possibility that the virtual persona's reaction is not appropriate for the user response.

In another embodiment of the process, the system selects an appropriate active listening video segment based on the best current understanding of the user's response.

The system can allow a real user to interrupt a virtual persona, and will simulate an “ad hoc” transition to an active listening shortly after detection of such interruption after selecting an appropriate “post-interrupted” active listening video segment (done within the response concept service system).

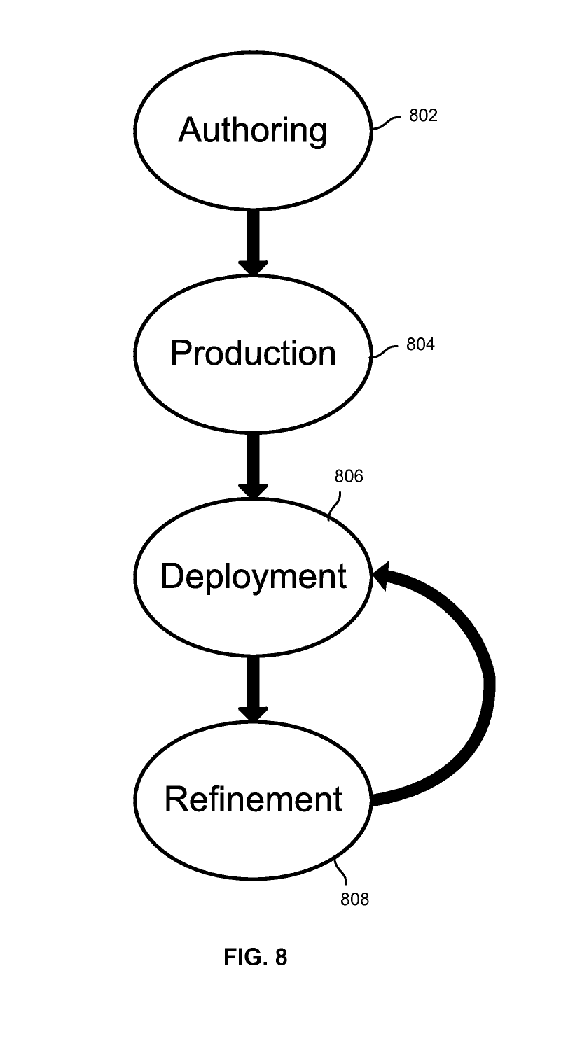

FIG. 8 is a flow chart illustrating an embodiment of a process to create content to provide a conversational video experience. In the example shown, the creation process includes an authoring phase 802, in which the content, purpose, and structure of a conversation are conceived; data representing the conversation and its structure is generated; and a script is written to be used to create video content for the segments that will be required to provide the conversational experience. In a production phase 804, video segments are recorded and associated with the conversation, e.g., by creating and storing appropriate meta-information. The relationships between segments comprising the conversational video experience are defined. For example, a conceptual understanding model is created which defines transitions to be made based on a best understanding by the system of a user's response to a segment that has just played. Once the required video content, understanding model(s), and associated meta-information have been created, they are packaged into sets of one or more files and deployed in a deployment phase 806, e.g., by distributing them to users via download and/or other channels. In the example shown, once the assets required to provide and/or consume the conversation video experience have been deployed, user interaction with the conversational video experience is observed in a refinement phase 808. For example, user interaction may indicate that one or more users provided a response to a segment that could not be mapped to a “response concept” recognized within the domain of the conversational video experience, e.g., to one of the response concepts associated with the segment and/or one or more other segments in an understanding model of the conversational video experience. In such a case, in the refinement phase 808 one or both of a speech recognition system/service and the understanding model of the conversational video experience may be tuned or otherwise refined or updated based on the observed interactions. For example, video and/or audio of one or more users interacting with the system, and the corresponding speech recognition and/or understanding service results, may be reviewed by a human operator (e.g., a designer, user, crowd-source worker) and/or programmatically to better train the speech recognition service to recognize an uttered response that was not recognized correctly and/or to update the model to ensure that a correctly recognized response can be mapped to an existing or if necessary a newly-defined response concept for the segment to which the user(s) was/were responding. The refined or otherwise updated assets (e.g., conceptual understanding model, etc.) are then deployed and further observation and refinement may occur.

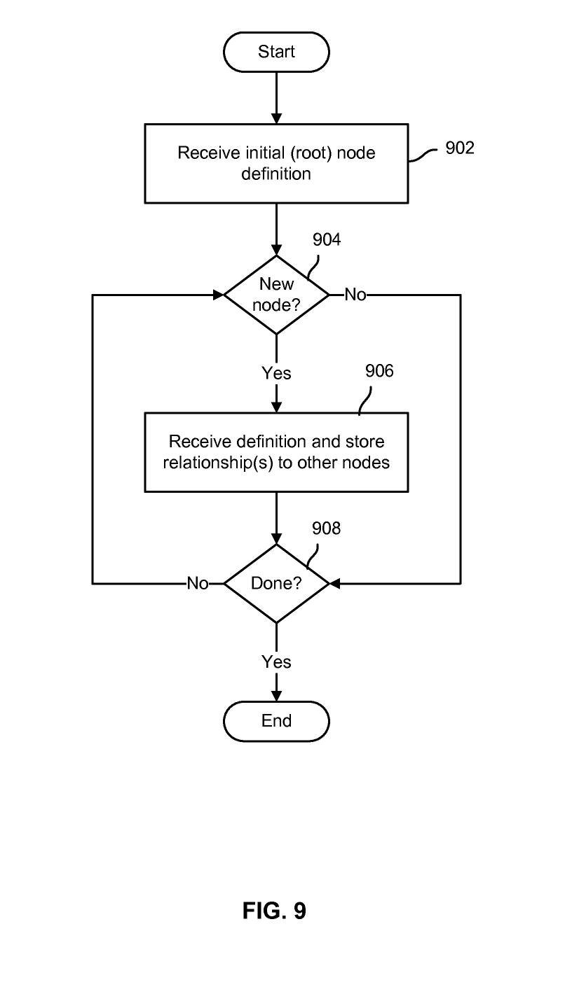

FIG. 9 is a flow chart illustrating an embodiment of a process to create content to provide a conversational video experience. In the example shown, a definition of an initial node, e.g., a root or other starting node, of a conversation is received (902). Iteratively, as successive indications that further nodes are desired to be added and defined (904), an interface is displayed and an associated node definition is received and stored, including as applicable information defining any relationship(s) between the defined node and other nodes (906). For example, a location of the node within a hierarchy of nodes comprising the conversation and/or a definition of one or more response concepts associated with the node and for each a consequence of a user response to a prompt provided via a video segment associated with the node being mapped to that response concept, may be received and stored. Once the authoring user indicates that (at least for now) no further nodes are desired to be defined (908), the process ends.

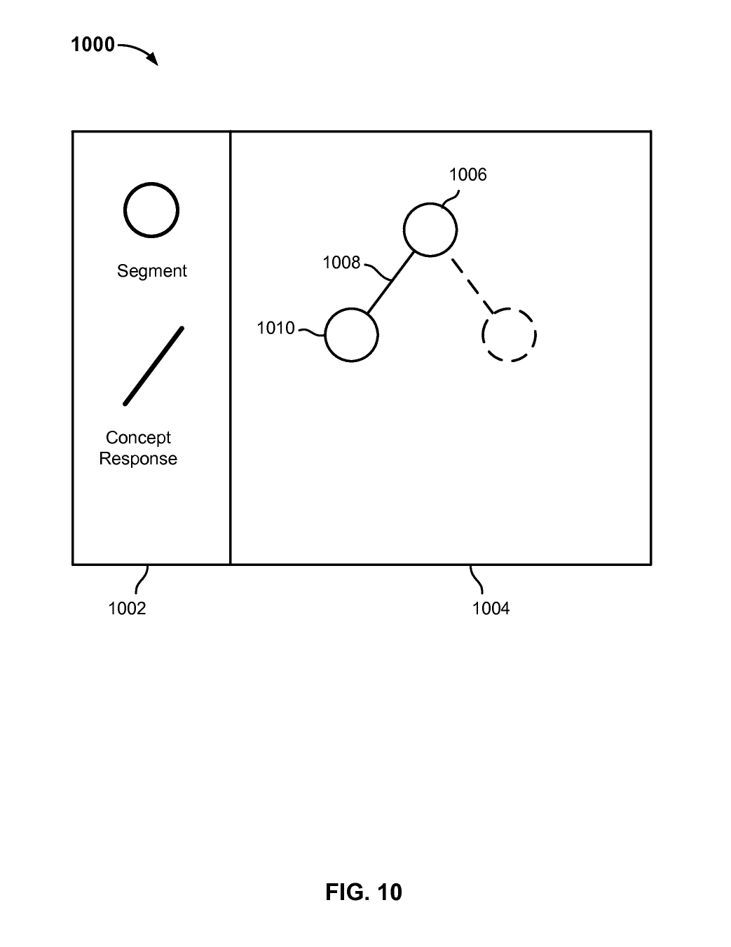

FIG. 10 is a block diagram illustrating an embodiment of a user interface of a tool to create content for a conversational video experience. In the example shown, the user interface (or portion thereof) 1000 includes a palette region 1002 and a workspace region 1004. In the example shown, the palette region 1002 includes two element types, the upper one to add a node and the lower one to add and define a transition between nodes, e.g., by dragging a dropping an instance of an element by clicking on the representation of the element type in the palette region 1002 and dragging it to a desire location in the workspace region 1004. In the state as shown in FIG. 10, a root node 1006, a transition 1008 (e.g., a response concept to a video segment associated with node 1006), and a second node 1010, to which a user who provides a response associated with response concept 1008 in response to a video segment associated with node 1006, have been defined. A further transition and destination node, shown in dashed lines in FIG. 10, would be defined by dragging and dropping the desired elements from the palette region 1002, and double clicking or otherwise selecting them to define their respective attributes.

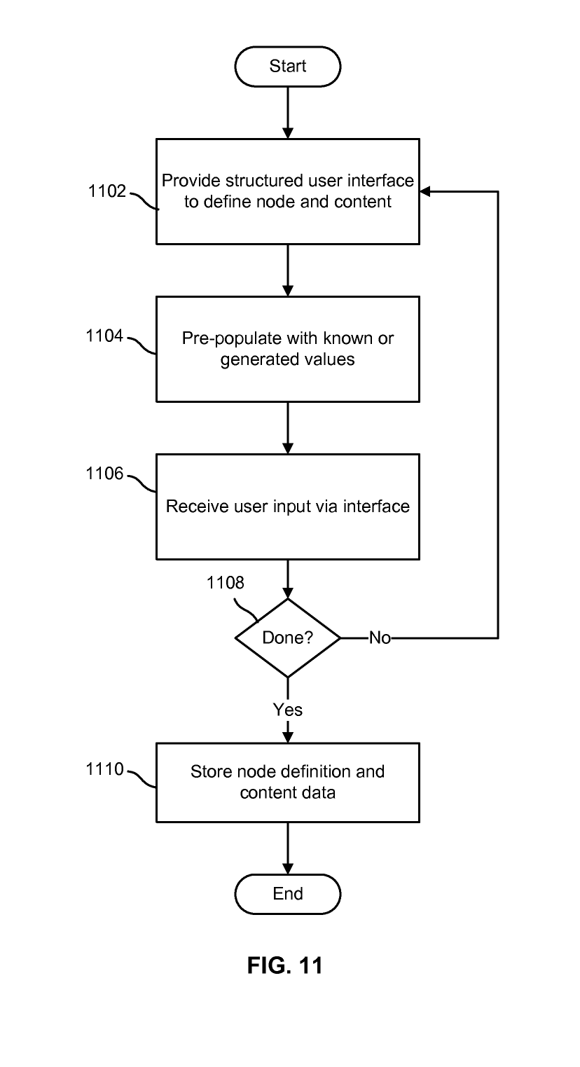

FIG. 11 is a flow chart illustrating an embodiment of a process to create content for a conversational video experience. In the example shown, a structured user interface is provided to enable an authoring user to define one or more nodes of a conversational video experience and for each its associated video content, understanding model (or elements thereof), etc. (1102). The user interface may be pre-populated with known (e.g., inherited and/or otherwise previously received or generated values) and/or generated values, if any (1104). For example, in some embodiments, as described more fully below, one or more nodes from another conversation may be re-used, or used as a template, in which case associated node values that have not (yet) been changed by the authoring user may be displayed. Authoring user input is received via the interface (1106). Once an indication is received that the authoring user is done defining a particular node (1108), the node definition and content data are stored (1110) and the process of FIG. 11 ends with respect to that node.

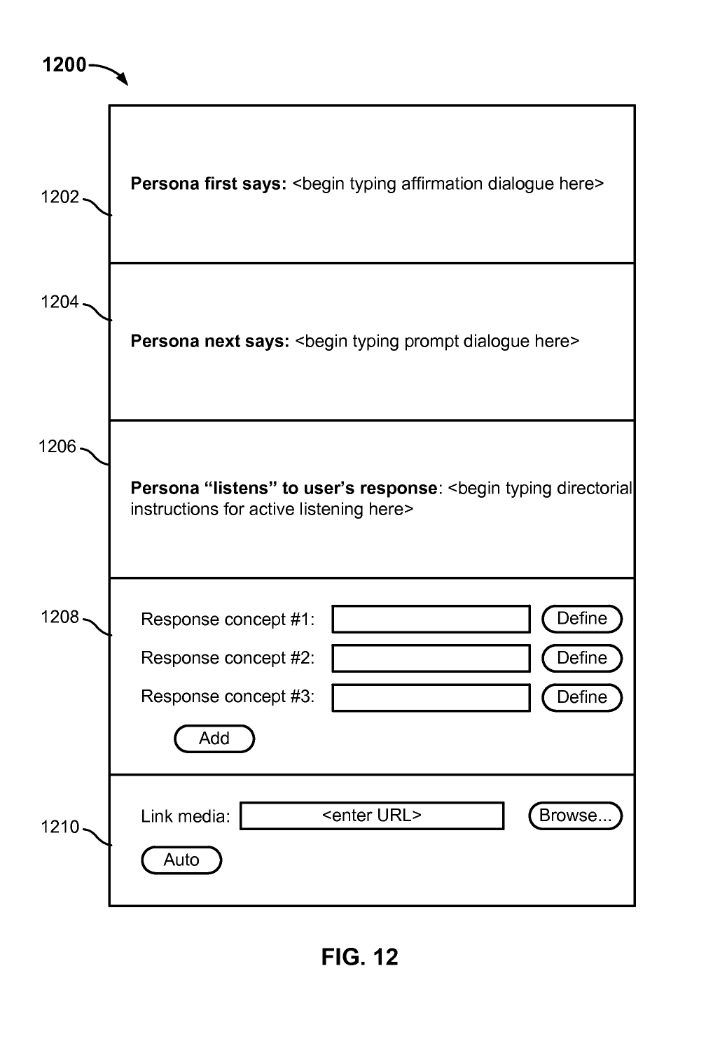

FIG. 12 is a block diagram illustrating an embodiment of a user interface of a tool to create content for a conversational video experience system. In the example shown, the user interface 1200 includes a first script entry region 1202, in which the authoring user is prompted to enter the words the actor or other person who will perform the segment should say during a first portion of a video content to be associated with the node. In the example shown, the authoring user is prompted to enter a statement that affirms a response the system would have understood the user to have given to a previous segment, resulting in their being transitioned to the current node. In a second script entry region 1204, the authoring user is prompted to enter words the video persona should say next, in this example to include a question or other prompt to which the user may be expected to respond. In an active listening direction entry section 1206, the authoring user is invited to provide instructions as to how the person who performs the video persona part should behave during an active listening portion of the video segment associated with the node, e.g., as described above. In various embodiments, script definition information entered in regions 1202, 1204, and/or 1206 may be used by a backend process or service to generate automatically and provide as output a script in a form usable by video production talent and production personnel to record a video segment to be associated with the node.

Referring further to FIG. 12, in the example shown the user interface 1200 further includes a response concept entry and definition section 1208. In the example shown, initially fields to define up to three response concepts are provided, and an “add” control is included to enable more to be defined. Text entry boxes are provided to enable response concept names or labels to be entered. For each a “define” button may be selected to enable key words, key phrases, Boolean and/or other combinations of words and phrases, etc. to be added as natural responses that are associated with and should be mapped by the system to the corresponding response concept. In some embodiments, as described more fully below, natural language and/or other processing may be performed on script text entered in regions 1202 and/or 1204, for example, to generate automatically and pre-populate in section 1208 one or more response concept candidates to be reviewed by and/or further defined by the authoring user. For example, in some embodiments, other response concepts that have already been defined for other nodes within the same conversation and/or associated with nodes in other conversations in a same subject matter and/or other common domain may be selected, based on the script text entered in regions 1202 and/or 1204, to be candidate response concept to the prompt entered in region 1204, for example.

Finally, the user interface 1200 includes a media linking section 1210. In the example shown, a URL or other identifier may be entered in a text entry field to link previously recorded video to the node. A “browse” control opens an interface to browse a local or network folder structure to find desired media. In the example shown, an “auto” button enables a larger video file to be identified, and in response to selection of the “auto” button the system will perform speech recognition to generate a time synchronized transcript for the video file, which will then be used to find programmatically the portion(s) of the video file that are associated with the node, for example those portions that match the script text entered in regions 1202 and/or 1204, and for the active listening portions a subsequent portion of the video until the earlier of the end of the file or when the subject resumes speaking.

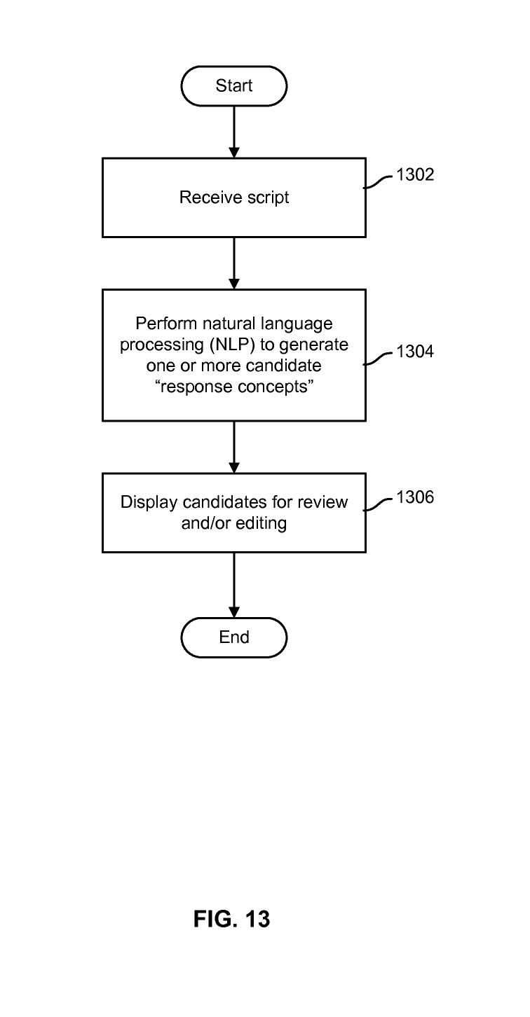

FIG. 13 is a flow chart illustrating an embodiment of a process to create content for a conversational video experience. In the example shown, a script is received (1302), e.g., a text or other file or portion thereof including text comprising all or a portion of a conversational video experience script. Natural language processing is performed to generate one or more candidate response concepts (1304). For example, the text for a prompt portion of a segment may be processed using a conversation domain-specific language understanding model to extract therefrom one or more concepts expressed and/or otherwise associated with the prompt. The same model may then be used to determine one or more responsive concepts that a user may be expected to express in response to the prompt, e.g., the same, similar, and/or otherwise related concepts. Response concept candidates are displayed to an authoring user for review and/or editing (1306), e.g., via a user interface such as described above in connection with FIG. 12.

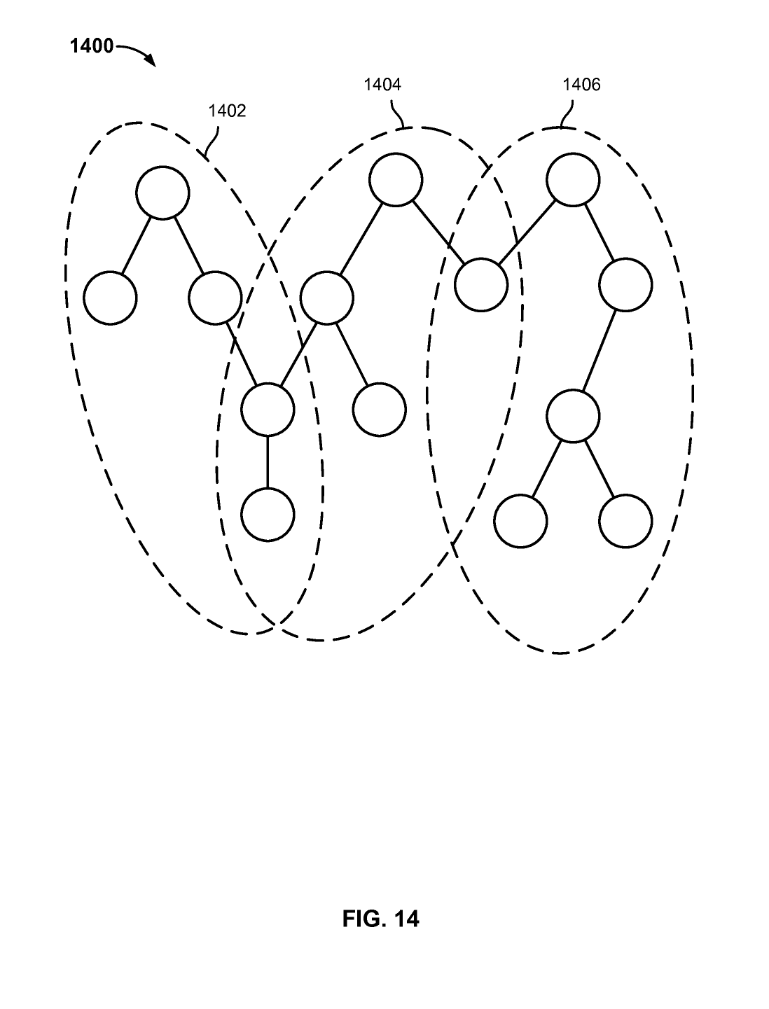

FIG. 14 is a block diagram illustrating an embodiment of related sets of content for a conversational video experience. In the example shown, a set 1400 of related conversations includes three conversations 1402, 1404, and 1406, respectively. Each conversation in this example comprises a hierarchically related set of conversation nodes, each having associated therewith one or more video segments, with “response concept” associated transitions between them. The dashed lines represent the boundaries of the individual conversations 1402, 1404, and 1406. As can be seen from FIG. 14, conversations 1402 and 1404 overlap, as do conversations 1404 and 1406. In various embodiments, an authoring system and/or tool provides an ability to discover existing conversation nodes to be incorporated (e.g., reused) in a new conversation that is being authored. For example, in the course of authoring conversation 1404, an authoring user may have been provided with a tool to discover and/or access and reuse the nodes shown in FIG. 14 in the area in which the respective dashed line ellipses identifying conversations 1402 and 1404 overlap. In some embodiments, the node definition may be reused, including associated resources, such as one or more of an associated script, node definition, video segment, and/or understanding model or portion thereof. In some embodiments, a reused node may be modified by an authoring user, for example by splitting of a “clone” or other modifiable copy specific to the new conversation that is being authored. Once a modification is made, a new copy of the cloned node is made and store separately from the original node, and changes are stored in the new copy, which from that point on is associated only with the new conversation.

In some embodiments, a set of conversations such as set 1400 of FIG. 14 may be associated with an “environment” or other shared logical construct. In various embodiments, configuration settings and/or other variables may be defined once for the environment, which will result in those settings and variables being inherited and/or otherwise used automatically across conversations associated with that environment. In some embodiments, environment variables and/or definitions provide and/or ensure a common “look and feel” across conversations associated with that environment.

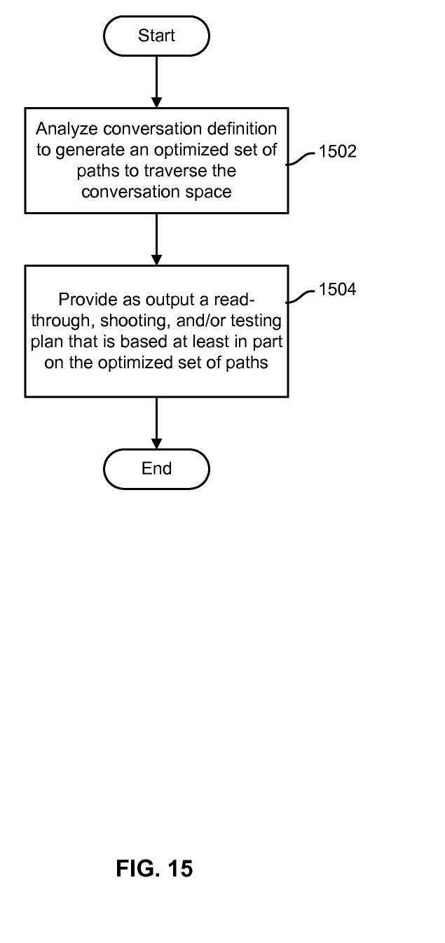

FIG. 15 is a flow chart illustrating an embodiment of a process to facilitate creation of content for a conversational video experience. In the example shown, a conversation that has been defined as described herein is analyzed to determine an optimized set of paths to traverse and explore fully the conversation space (1502). Output to be used to produce in an efficient way video assets required to provide a video conversational experience based on the definition are generated programmatically based at least in part on the determined optimized set of paths (1504). Examples include, without limitation, scripts to be used to perform a read-through and/or shoot video segments in an efficient order; a plan to shoot the required video; and/or a testing plan to ensure that test users explore the conversation space fully and efficiently. In various embodiments, printed scripts, files capable of being rendered by a teleprompter, and/or other assets in any appropriate format may be generated.

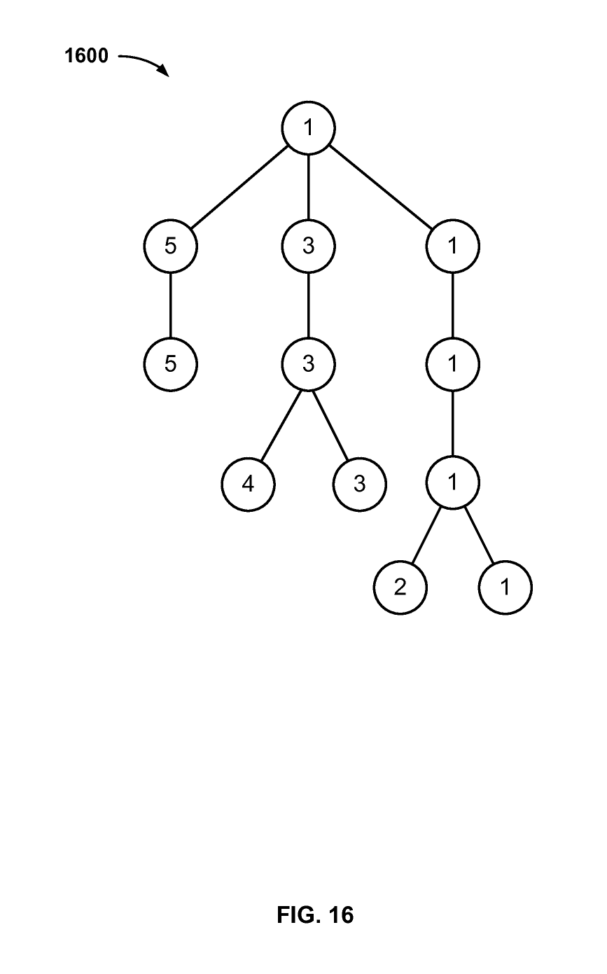

FIG. 16 is a block diagram illustrating an embodiment of a set of content for a conversational video experience. In the example shown, a set of optimized paths to explore a conversation space 1600 have been determined. For example, to read-through or shoot the required video segments, a script, plan, or other output based on the paths shown in FIG. 16 might present segment (node) information first for the nodes labeled “1”, then the alternate end node “2”, then the three nodes labeled “3”, followed by the alternate end node “4”, and finally the branch comprising the nodes labeled “5”. The simplified example shown in FIG. 16 includes a fairly small number of nodes, but one can see that the advantage of automated path and/or plan or other resource generation would be even greater with respect to a conversation having many more nodes. While in the example shown in FIG. 16 the optimized paths through the space are based on hierarchical relationships, in other embodiments efficient ways to cover the conversation space may be determined at least in part based on other information, such as natural language or other processing of node-related content to identify nodes with common themes, and/or navigating through nodes based on conceptual or other relationships.

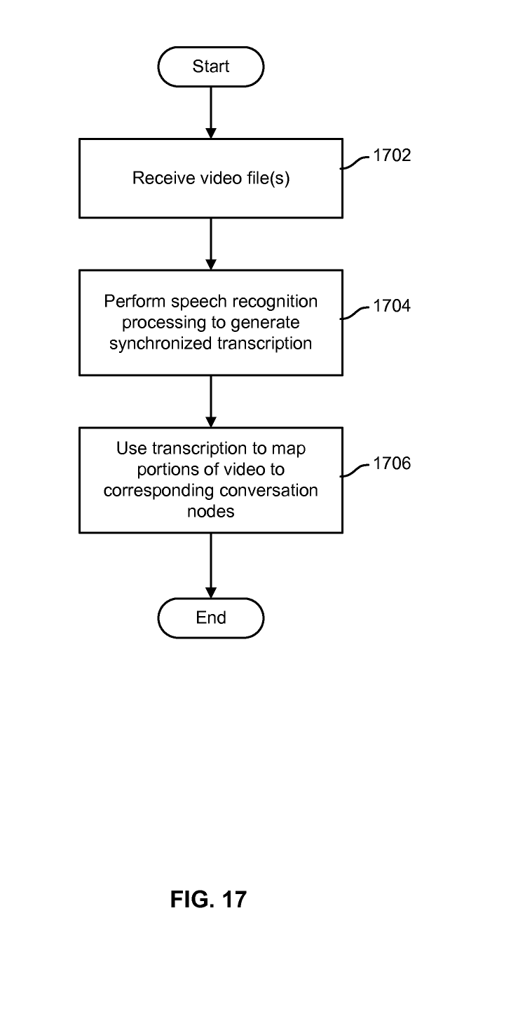

FIG. 17 is a flow chart illustrating an embodiment of a process to facilitate creation of content for a conversational video experience. In the example shown, once the video for a conversation has been generated, automated processing is performed to identify within a larger video file and/or set of files the portion(s) of video content that are related to a given node. One or more video files are received (1702). Speech recognition processing is perform on the audio portion of the video data to generate a synchronized transcription (1704), e.g., a text transcript with timestamps, offsets, and/or other meta-information indicating for each part of the transcript a corresponding portion of the video file(s). The transcription is used to map portions of the video file(s) to corresponding conversation nodes (1706). For example, a match within the transcription may be found for a node-specific script. Information indicating a beginning and end of a corresponding portion of the video file(s) may be used to tag or otherwise map the corresponding video content to the conversation node with which that portion of the script and corresponding portion of the transcription are associated.

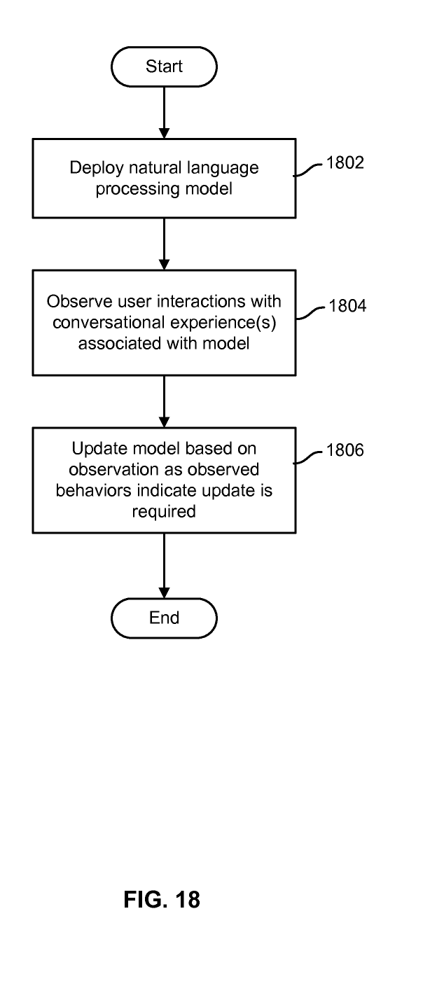

FIG. 18 is a flow chart illustrating an embodiment of a process to facilitate creation of content for a conversational video experience. In the example shown, user interaction with a conversation video experience is observed and feedback based on the observation is used to update an associated understanding and/or speech recognition model. In the example shown, a natural language processing-based understanding model is deployed (1802), e.g., in connection with deployment of a conversational video experience. User interactions with one or more conversational video experiences with which the understanding model is associated are observed (1804). For example, observed instances in which the system is unable to determined based on user utterances a response concept to which the user's response should be mapped may be analyzed programmatically and/or by a human operator to train associated speech recognition services and/or to update the understanding model to ensure that going forward the system will recognize previously-misunderstood or not-understood responses as being associated with an existing and/or newly-defined response concept (1806). The understanding model and/or other resource, once updated, is deployed and/or re-deployed, as described above.

Using techniques disclosed herein, a more natural, satisfying conversational video experience may be produced and provided to users.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of producing a conversational video experience, comprising:
receiving via a user interface a definition data associated with a first conversation node associated with the conversational video experience;
determining based at least in part on the received definition data a response concept associated with the first conversation node;
determining based at least in part on the determined response concept a relationship between the first conversation node and a second conversation node associated with the conversational video experience; and
generating and storing an association data that represents the relationship.

2. The method of claim 1, wherein the definition data includes an indication of the response concept.

3. The method of claim 1, wherein the definition data includes a script data and determining the response concept includes performing natural language processing based on the script data to determine one or more concepts associated with the script data.

4. The method of claim 3, wherein determining the response concept further includes using an understanding model to determine, based at least in part on the one or more concepts, that the response concept is associated with one or more of the one or more concepts.

5. The method of claim 1, wherein the relationship between the first conversation node and a second conversation node is determined based at least in part by determining that the second node also associated with the response concept.

6. The method of claim 5, wherein the second conversation node includes an affirmation portion associated with the response concept.

7. The method of claim 1, wherein the first and second conversation nodes are included in a set of conversation nodes comprising the conversational video experience, and generating and storing the association data that represents the relationship includes storing meta-information that indicates for each of the first and second conversation nodes a location within a hierarchical or other structure of the set of conversation nodes.

8. The method of claim 7, wherein generating and storing the association data that represents the relationship further includes storing meta-information that indicates that a conversation state of an instance of interaction with the conversational video experience should be advanced to the second conversation node in the event that a user response to a video prompt associated with the first conversation node is mapped to the response concept.

9. The method of claim 1, further comprising generating, based at least in part on one or both of the definition data and the response concept a user response understanding model to be used to interpret user responses to a video segment associated with one or both of the first conversation node and the second conversation node.

10. The method of claim 1, wherein the definition data includes an indication of a previously-defined conversation node.

11. The method of claim 10, further comprising providing a user interface to enable an authoring user to modify one or more attributes of the previously-defined conversation node.

12. The method of claim 1, further comprising observing the respective interactions of one or more users with the conversational video experience and updating an understanding model associated with the conversational video experience based at least in part on said observation.

13. The method of claim 12, wherein updating the understanding model includes mapping one or more words or key phrases uttered by said users in response to a video segment associated with the first conversation node to said response concept.

14. A system to create content to provide a conversational video experience, comprising:
a display device; and
a processor couple to the display device and configured to:
receive via a user interface displayed via the display device a definition data associated with a first conversation node associated with the conversational video experience;
determine based at least in part on the received definition data a response concept associated with the first conversation node;
determine based at least in part on the determined response concept a relationship between the first conversation node and a second conversation node associated with the conversational video experience; and
generate and store an association data that represents the relationship.

15. The system of claim 14, wherein the definition data includes an indication of the response concept.

16. The system of claim 14, wherein the definition data includes a script data and determining the response concept includes performing natural language processing based on the script data to determine one or more concepts associated with the script data.

17. The system of claim 14, wherein the relationship between the first conversation node and a second conversation node is determined based at least in part by determining that the second node also associated with the response concept.

18. The system of claim 17, wherein the second conversation node includes an affirmation portion associated with the response concept.

19. The system of claim 14, wherein the processor is further configured to observe the respective interactions of one or more users with the conversational video experience and update an understanding model associated with the conversational video experience based at least in part on said observation.

20. A computer program product embodied in a non-transitory computer readable storage medium, comprising computer instructions for:
receiving via a user interface a definition data associated with a first conversation node associated with the conversational video experience;
determining based at least in part on the received definition data a response concept associated with the first conversation node;
determining based at least in part on the determined response concept a relationship between the first conversation node and a second conversation node associated with the conversational video experience; and
generating and storing an association data that represents the relationship.
